(19) United States
(12) Patent Application Publication
(10) Pub. No.: US 2015/0031501 A1
(43) Pub. Date: Jan. 29, 2015

(54) HYBRID-ELECTRIC VEHICLE WITH CONTINUOUSLY VARIABLE TRANSMISSION

(71) Applicant: GM GLOBAL TECHNOLOGY OPERATIONS LLC, Detroit, MI (US)

(72) Inventors: Joseph M. Tolkacz, Novi, MI (US); Robert L. Moses, Ann Arbor, MI (US); Min-Joong Kim, Troy, MI (US)

(73) Assignee: GM GLOBAL TECHNOLOGY OPERATIONS LLC, Detroit, MI (US)

(21) Appl. No.: 13/949,296

(22) Filed: Jul. 24, 2013

(51) Int. Cl. B60W 20/00

(52) U.S. Cl. CPC B60W 20/30; Y10S 903/902
USPC 477/5; 180/65.22; 903/902

(57) ABSTRACT

A hybrid-electric vehicle having a continuously variable transmission is provided. The continuously variable transmission further includes a forward disconnect clutch configured to selectively couple and decouple the continuously variable transmission and a first set of drive wheels. The hybrid-electric vehicle further includes a rear e-axle assembly, which allows the vehicle to operate in an electric-only mode, in which the vehicle is propelled with power generated solely by at least one electric power component. When the vehicle is operated in electric-only mode, the transmission disconnect clutch is disengaged, such that the continuously variable transmission is decoupled from the first set of drive wheels to allow the continuously variable transmission to operate in a low loss state. A method of transitioning an all-wheel drive hybrid-electric vehicle between an electric only mode and a hybrid mode, i.e., completing a “flying start,” is also provided.

### TECHNICAL FIELD

The present teachings generally include a vehicle, configured as a hybrid-electric vehicle, having a continuously variable transmission.

### BACKGROUND

In general, a continuously variable transmission is a transmission that can change steplessly through an infinite number of effective gear ratios between a maximum gear ratio and a minimum gear ratio.

A typical belt-type continuously variable transmission includes two pulleys, each having two sheaves. A belt runs between the two pulleys, with the two sheaves of each of the pulleys sandwiching the belt therebetween. Frictional engagement between the sheaves of each pulley and the belt couples the belt to each of the pulleys to transfer torque from one pulley to the other. One of the pulleys may function as a drive or input pulley so that the other pulley (an output or driven pulley) can be driven by the drive pulley via the belt. The gear ratio is the ratio of the torque of the driven pulley to the torque of the drive pulley. The gear ratio may be changed by moving the two sheaves of one of the pulleys closer together and the two sheaves of the other pulley farther apart, causing the belt to ride higher or lower on the respective pulley.

A toroidal continuously variable transmission is made up of discs and roller mechanisms that transmit power between the discs. The toroidal continuously variable transmission includes at least one input disc, connected to the engine, and one output disc operatively connected to the transmission output. The input disc and output disc define a cavity therebetween. The cavity defines a toroidal surface. The roller mechanism is placed within the cavity and is configured to vary the torque transmission ratio as the roller mechanism moves across the torodial surface. A simple tilt of the roller mechanism within the cavity changes the relative diameter of engagement of the input disc and output disc and incrementally changes the torque transmission ratio, providing for smooth, nearly instantaneous changes in torque transmission ratio. Thus, toroidal continuously variable transmissions are able to handle extremely high torques at high efficiencies.

### SUMMARY

A hybrid-electric vehicle having a continuously variable transmission is provided. The vehicle includes a first set of drive wheels and a second set of drive wheels. The vehicle further includes a primary power source having a rotatable output member for transmitting torque to the continuously variable transmission.

The continuously variable transmission is configured to transmit torque from the primary power source to the first set of drive wheels. The continuously variable transmission may be one of a belt-type continuously variable transmission and a toroidal continuously variable transmission. The continuously variable transmission further includes a forward disconnect clutch configured to selectively couple and decouple the continuously variable transmission and the first set of drive wheels.

The hybrid-electric vehicle further includes an auxiliary power source. The auxiliary power source is operatively connected to the second set of drive wheels and configured to transmit torque thereto.

A method of transitioning an all-wheel drive hybrid electric vehicle between an electric-only mode and a hybrid operating mode, i.e. completing a “flying start,” is also provided. The method comprises the steps of: detecting a request, via a controller, for a change from an electric-only operating mode to a hybrid operating mode; signaling a desired change from the electric-only operating mode to the hybrid operating mode, with the controller; starting a first electric power component to crank an engine; determining a desired engine speed and a desired engine torque to generate the desired level of transmission output torque, with the controller; engaging a forward disconnect clutch to selectively couple the continuously variable transmission with a first set of drive wheels; and powering the vehicle with torque transferred from the continuously variable transmission to the first set of drive wheels and torque transferred from a second electronic power component to a second set of drive wheels in the hybrid operating mode.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic illustration of an all-wheel drive hybrid-electric vehicle having a continuously variable transmission.

FIG. 2 is a schematic perspective and partially cross-sectional view of an example belt-type continuously variable transmission.

FIG. 3 is cross-sectional view of an example belt-type continuously variable transmission.

FIG. 4 is a schematic perspective view of an example toroidal-type continuously variable transmission.

FIG. 5 is a cross-sectional view of an example toroidal-type continuously variable transmission.

FIG. 6 is a flow diagram detailing a method of transitioning an all-wheel drive hybrid-electric vehicle between a present operating mode and a target operating mode, wherein the present operating mode is an electric-only mode and the target operating mode is a hybrid mode, i.e., completing a “flying start.”

### DETAILED DESCRIPTION

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

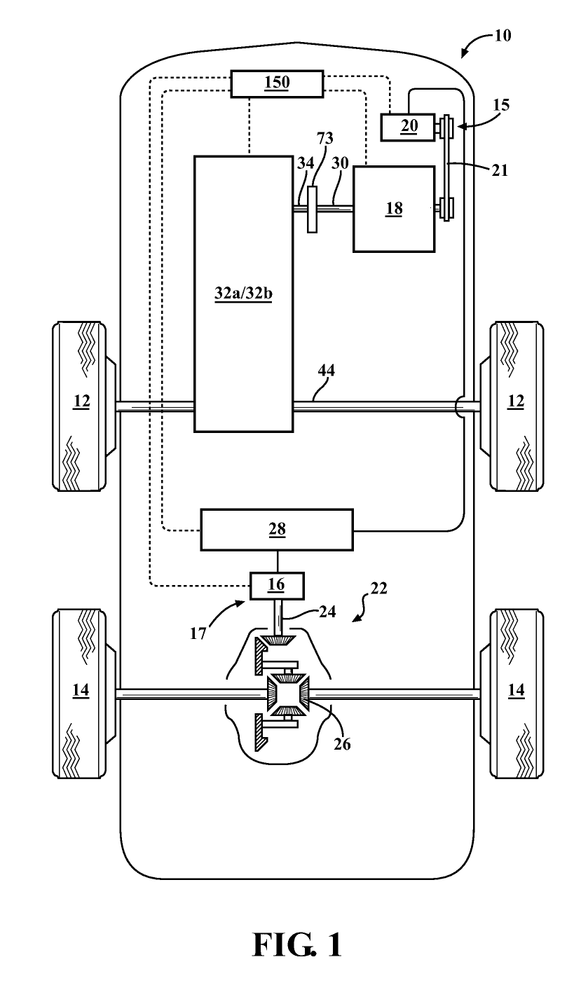

Referring to Figures, wherein like numerals indicate like parts throughout the several views, a hybrid-electric vehicle 10 is provided. FIG. 1 illustrates a hybrid-electric vehicle 10 equipped with an electric all-wheel drive system. The vehicle 10 includes a primary power source 15 and an auxiliary power source 17. The primary power source 15 may include an internal combustion engine 18 and a first electronic power component 20 configured to drive the vehicle via a first set of wheels 12 through a continuously variable transmission 32a, 32b and a first axle 44. The auxiliary power source 17 may include a second electronic power component 16 configured to drive a second set of drive wheels 14.

The first and second electronic power components 16, 20 receive power from a power storage device 28, which is electrically interconnected therewith. The power storage device 28 is configured to transmit power to and receive power from the first electronic power component 20, transmit power to the second electronic power component 16, and provide power to other electronic devices requiring power throughout the vehicle 10.

The internal combustion engine 18 includes a rotatable output member 30 configured to transmit torque to a continuously variable transmission 32a, 32b via a transmission input member 34. The transmission input member 34 may be fluidly coupled to the rotational output member 30 via a torque converter 73.

The first electronic power component 20 may be a first motor-generator unit, as shown in the example embodiment of FIG. 1. The first electronic power component 20 may be connected directly to the engine 18 via a belt 21. The first electronic power component 20 is further operatively connected to the power storage device 28 such as a high voltage battery or the like. When the first electronic power component 20 operates as a motor, it receives electrical energy from the power storage device 28 to drive the continuously variable transmission 32a, 32b or crank the engine 18. When the first electronic power component 20 operates as a generator, it transmits electrical energy to the power storage device 28 to charge the power storage device 28. Accordingly, the continuously variable transmission 32a, 32b may be driven by one of the internal combustion engine 18 only, the first electronic power component 20 only, and a combination of the internal combustion engine 18 and the first electronic power component 20.

The hybrid vehicle 10 further includes a second axle, which is configured as a fully electronic rear axle or a “rear e-axle assembly” 22. The rear e-axle assembly 22 is operatively independent from the engine 18, the continuously variable transmission 32a, 32b, and the first electronic power component 20. The rear e-axle assembly 22 includes the second electronic power component 16, having a second electronic power component output 24. The second electronic power component 16 may be one of an electric motor and a second motor-generator unit as shown in FIG. 1. The rear e-axle assembly 22 further includes a rear differential 26 configured to receive torque from the second electronic power component output 24, and further configured to transmit torque to a second set of drive wheels 14 to propel the vehicle 10.

The second electronic power component 16 receives its electrical energy from the power storage device 28. Accordingly, the second electronic power component 16 is configured to drive the vehicle 10 independently of the engine 18 and provides the vehicle 10 with an on-demand electric axle drive. The on-demand electric axle drive results in the vehicle 10 being operated in a purely electric vehicle or “electric-only mode.” Furthermore, when both the first axle 44 and the rear e-axle assembly 22 are driven by their respective power sources 15, 17, the vehicle 10 is endowed with all-wheel drive, and may operate in an “electric all-wheel drive mode.”

In the electric-only operating mode, the vehicle 10 operates on power supplied solely by the second electric power component 16. In hybrid operating mode, the vehicle 10 operates on power supplied by the internal combustion engine 18 and the second electric power component 16. The vehicle 10 is further capable of operating in an engine-only mode, wherein the vehicle 10 operates and is propelled via power supplied solely by the internal combustion engine 18.

The vehicle 10 is configured to operate in several powertrain configurations. The vehicle 10 may operate as a rear-wheel drive vehicle, through the use of the rear e-axle assembly 22. The vehicle 10 may operate as an all-wheel drive vehicle, through the use of the rear e-axle assembly 22 simultaneously with the front-wheel drive configuration in which torque is transmitted to the first set of drive wheels 12 from the internal combustion engine 18. The vehicle 10 may operate as a front-wheel drive vehicle, in which torque is transmitted solely to the first set of drive wheels 12 from the internal combustion engine 18.

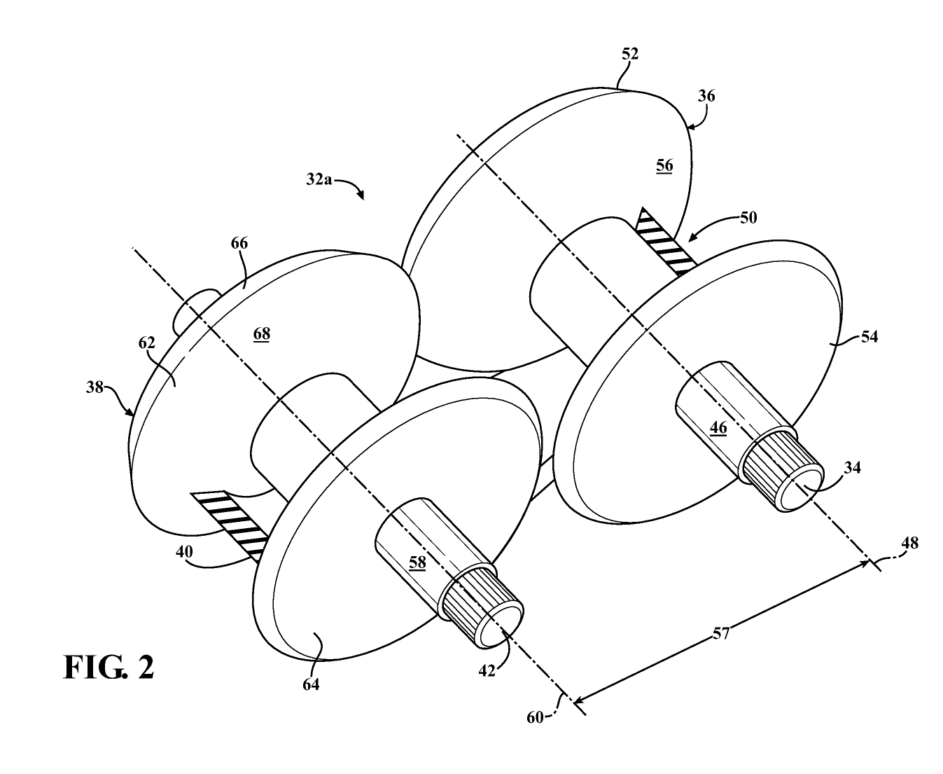

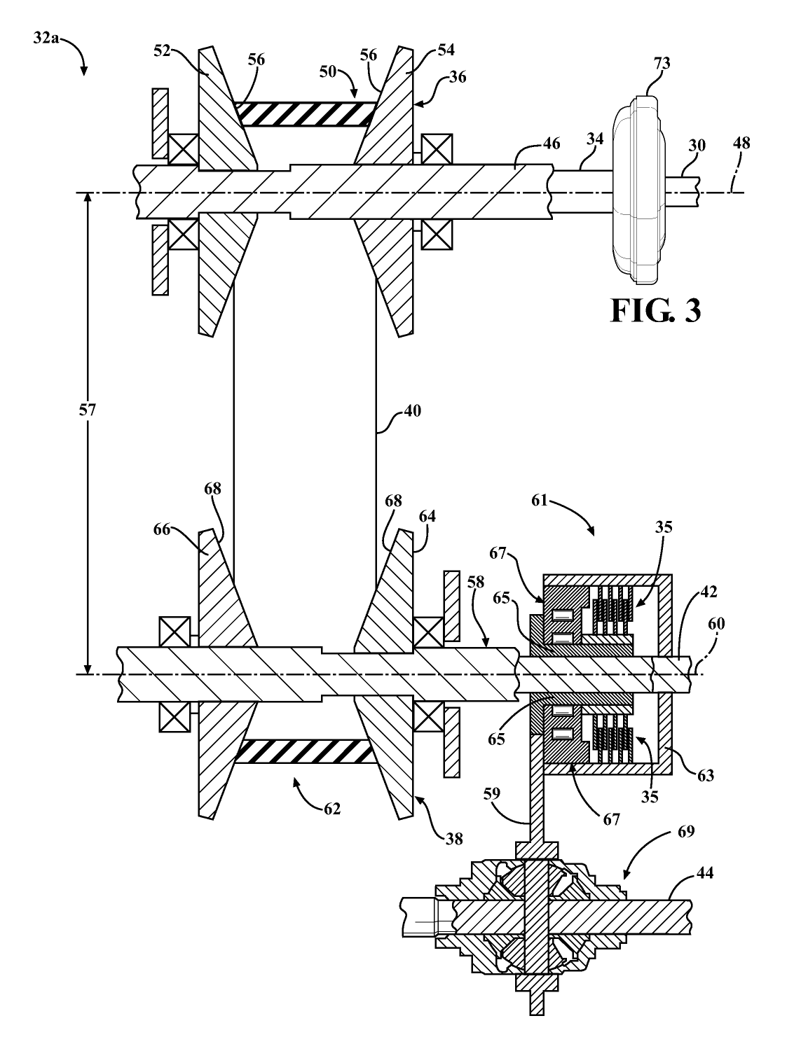

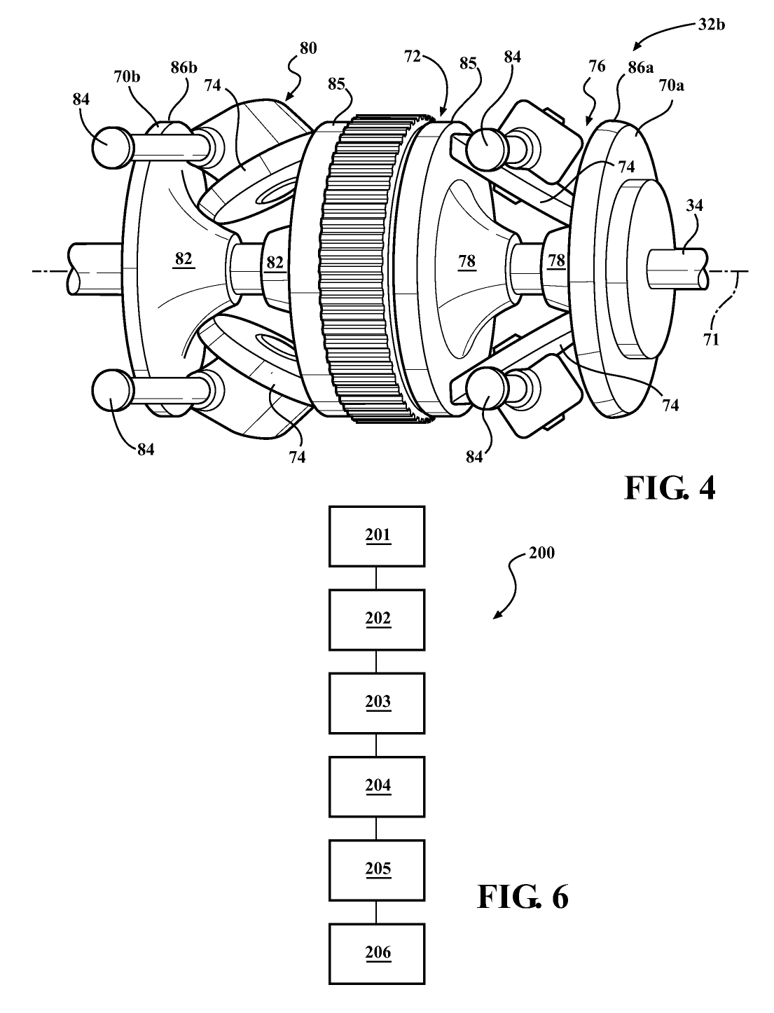

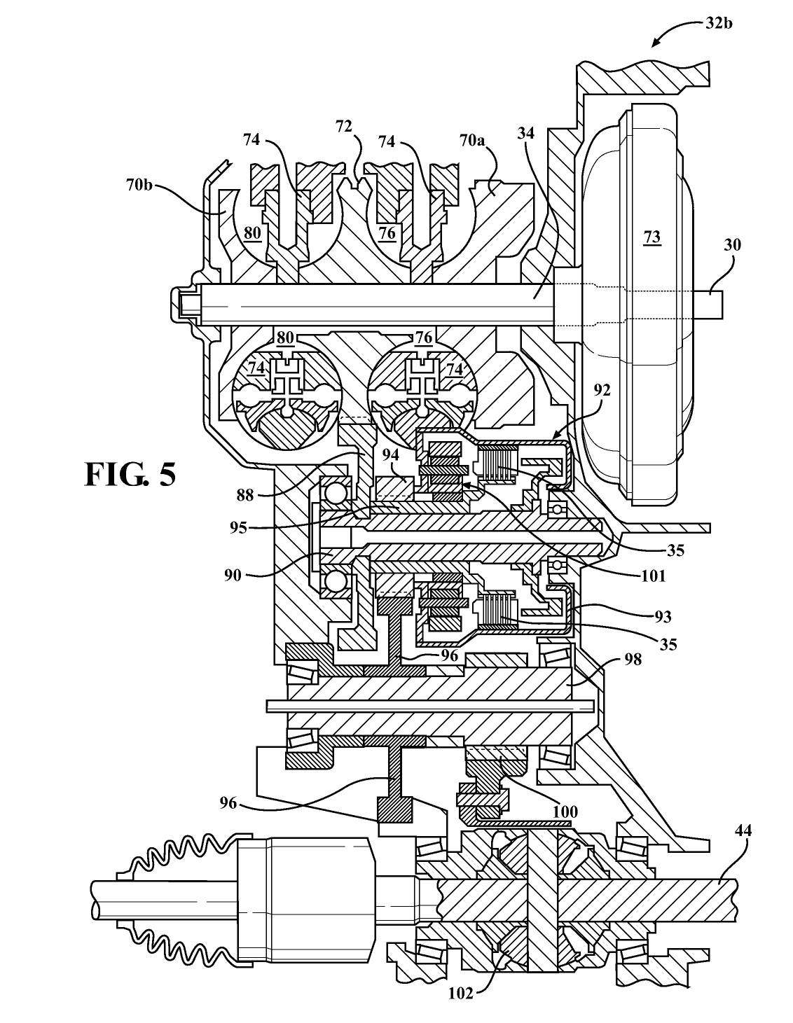

The continuously variable transmission 32a, 32b can change steplessly through an infinite number of effective gear ratios, between a maximum gear ratio and a minimum gear ratio. The continuously variable transmission 32a, 32b is configured to transmit torque from the engine 18 and/or first electronic power component 20 to the first set of drive wheels 12. The continuously variable transmission 32a, 32b may be one of a belt-type continuously variable transmission 32a (shown in FIGS. 2 and 3) and a toroidal continuously variable transmission 32b (shown in FIGS. 4 and 5). Each configuration of the continuously variable transmission 32a, 32b includes a transmission input member 34 configured to transfer torque from the rotatable output member 30 to the continuously variable transmission 32a, 32b. The continuously variable transmission 32a, 32b further includes a forward disconnect clutch 35. The forward disconnect clutch 35 is disposed between the variator of the respective continuously variable transmission 32a, 32b and the first set of drive wheels 12 and is configured to selectively couple and decouple the continuously variable transmission 32a, 32b and the first set of drive wheels 12.

Referring to FIGS. 2-3, a belt-type continuously variable transmission 32a is shown. The belt-type continuously variable transmission 32a has a first pulley 36 and a second pulley 38, with an endlessly rotatable device 40 surrounding the pulleys 36, 38 and adapted to transfer torque between the pulleys 36, 38. For example, the transmission input member 34 maybe connected to rotate in unison with the first pulley 36 to a transmission output member 42 connected to rotate in unison with the second pulley 38, when the forward disconnect clutch 35 is applied. The continuously variable transmission 32a uses the effective gear ratio to convert the rotational output speed of the primary power source 15, i.e., the engine 18 and/or the motor-generator unit 20 into a desired torque for an output device, i.e., the first axle 44 (shown in FIG. 1).

The belt-type continuously variable transmission 32a may further include the transmission input member 34, which is operatively connected to the output member 30 of the primary power source 15. For example, the output member 30 may be an engine crankshaft or the like which allows for the transmission input member 34 to rotate therewith.

The belt-type continuously variable transmission 32a further includes the first pulley 36. The first pulley 36 includes a first pulley axle 46 operatively connected to and configured to rotate with the transmission input member 34, when the transmission input member 34 receives a rotational input. The transmission input member 34 and the first pulley axle 46 extend along and rotate about an input axis 48. The first pulley 36 may alternatively be referred to as an input pulley or a drive pulley. The first pulley 36 is rotatable with the transmission input member 34 and first axle 46 about the input axis 48. The input pulley 36 is split perpendicular to the input axis 48 to define an annular input groove 50 therebetween. The annular input groove 50 is disposed perpendicular to the input axis 48.

The first pulley 36 includes a moveable input sheave 52, and a stationary input sheave 54. The moveable input sheave 52 is axially moveable along the input axis 48 relative to the first pulley axle 46. For example, the moveable input sheave 52 may be attached to the first pulley axle 46 via a splined connection, thereby allowing axial movement of the moveable input sheave 52 along the input axis 48. The stationary input sheave 54 is disposed opposite the moveable input sheave 52. The stationary input sheave 54 is axially fixed along the input axis 48 relative to the first pulley axle 46. As such, the stationary input sheave 54 does not move in the axial direction of the input axis 48 along the first pulley axle 46. The moveable input sheave 52 and the stationary input sheave 54 each include an input groove surface 56. The input groove surface 56 of each of the moveable input sheave 52 and the stationary input sheave 54 are disposed opposite each other to define the annular input groove 50 therebetween.

The second pulley 38 includes a second pulley axle 58, which is operatively connected to the transmission output member 42. The transmission output member 42 and the second pulley axle 58 extend along and rotate about an output axis 60. The input axis 48 and the output axis 60 are parallel with each other and spaced from each other a fixed distance 57. The second pulley 38 may alternatively be referred to as an output pulley or a driven pulley. The second pulley 38 is rotatable with the second pulley axle 58 about the output axis 60. The second pulley 38 is split perpendicular to the output axis 60 to define an annular output groove 62 therebetween. The annular output groove 62 is disposed perpendicular to the output axis 60. The second pulley axle 58 is operatively connected and configured to rotate with the transmission output member 42, when the forward disconnect clutch 35 is applied.

The second pulley 38 further includes a moveable output sheave 64, and a stationary output sheave 66. The moveable output sheave 64 is axially moveable along the output axis 60 relative to the second pulley axle 58. For example, the moveable output sheave 64 may be attached to the second axle 58 via a splined connection, thereby allowing axial movement of the moveable output sheave 64 along the output axis 60. The stationary output sheave 66 is disposed opposite the moveable output sheave 64. The stationary output sheave 66 is axially fixed along the output axis 60 relative to the second pulley axle 58. As such, the stationary output sheave 66 does not move in the axial direction of the output axis 60 along the second pulley axle 58. The moveable output sheave 64 and the stationary output sheave 66 each include an output groove surface 68. The output groove surface 68 of each of the moveable output sheave 64 and the stationary output sheave 66 are disposed opposite each other to define the annular output groove 62 therebetween.

The first pulley 36 has a first pulley diameter and the second pulley 38 has a second pulley diameter. The ratio of the second pulley diameter to the first pulley diameter defines the transmission torque ratio.

The belt-type continuously variable transmission 32a may further include clutch assembly 61 contained within a clutch housing 63. The clutch assembly 61 includes the forward disconnect clutch 35 operatively connected to the clutch housing 63, a hollow shaft 65 disposed about the transmission output member 42, and a planetary gear set 67.

The forward disconnect clutch 35 acts as a disconnect clutch, which selectively couples and decouples the continuously variable transmission 32a and the first set of drive wheels 12. When applied, the forward disconnect clutch 35 couples the clutch housing 63 and the hollow shaft 65, allowing the clutch housing 63, forward disconnect clutch 35, and the hollow shaft 65 to rotate in unison with the transmission output member 42. The hollow shaft 65 and the clutch housing 63 are further operatively connected to the planetary gear set 67 and configured to transfer torque thereto, when the forward clutch 35 is applied. Essentially, when the forward disconnect clutch 35 is applied, the clutch assembly 61 transmits the output rotation from the transmission output member 42 to the planetary gear set 67.

The continuously variable transmission 32a may further include at least one transfer gear 59 configured receive torque from the planetary gear set 67 and transmit torque to a front differential 69. The front differential 69 is configured to receive torque form the at least one transfer gear 59 and transmit torque to the first set of drive wheels 12 via an output device, i.e., the first axle 44.

When the forward clutch 35 is applied, the clutch assembly 61 transmits the output rotation from the transmission output member 42 to the first set of drive wheels 12. When the forward clutch 35 is disengaged, the output rotation from the transmission output member 42 is not transmitted to the first set of drive wheels 12. This disengagement of the continuously variable transmission 32a from the first set of drive wheels 12 allows the continuously variable transmission 32a to operate in a low loss state when the vehicle 10 is operating in electric-only mode, powered solely by the rear e-axle assembly 22.

Referring to FIGS. 4 and 5, a toroidal continuously variable transmission 32b is shown. The toroidial continuously variable transmission 32b is disposed about the transmission input member 34 along the input axis 71. The transmission input member 34 is operatively connected to the rotatable output member 30. The transmission input member 34 may be fluidly coupled to the rotatable output member 30 with a torque converter 73 or the like.

The toroidal continuously variable transmission 32b includes a pair of opposed drive discs 70a, 70b, a driven disc 72, and a plurality of roller mechanisms 74. The pair of opposed drive discs 70a, 70b includes a first drive disc 70a and a second drive disc 70b. The first drive disc 70a, the second drive disc 70b, and the driven disc 72 are disposed along and rotatable about the input axis 71. Each of the first drive disc 70a and the second drive disc 70b is operatively connected to and integrally rotatable with the transmission input member 34.

The driven disc 72 is disposed coaxially between the first drive disc 70a and the second drive disc 70b. The first drive disc 70a and the driven disc 72 define a first cavity 76, having a first toroidal surface 78. The second drive disc 70b and the driven disc 72 define a second cavity 80, having a second toroidal surface 82.

At least one roller mechanism 74 is disposed within each of the first cavity 76 and the second cavity 80. Each respective roller mechanism 74 is rotatable about its own respective roller mechanism axis, and is configured to transfer torque from one of the first drive disc 70a and second drive disc 70b to the driven disc 72. Each roller mechanism 74 moves along one of the respective first toroidal surface 78 and second toroidal surface 82 to vary the ratio between the speed of the transmission input member 34 and the driven disc 72.

When the roller mechanism 74 is in contact with the respective drive disc 70a, 70b near its center, the roller mechanism 74 contacts the driven disc 72 near its exterior rim 85, resulting in a reduction in speed and an increase in torque (i.e., low gear). When the roller mechanism 74 is in contact with the respective drive disc 70a, 70b near its exterior rim 86a, 86b, the roller mechanism 74 is correspondingly in contact with the driven disc 72 near its center. This results in an increase in speed and a decrease in torque (i.e., high gear).

Each respective roller mechanism 74 is operatively connected to and supported by a trunnion 84. Each trunnion 84 is configured to tilt or rotate its corresponding roller mechanism 74 about its respective roller mechanism axis. A simple tilt of the roller mechanism 74 within the cavity 76, 80 changes the relative diameter of engagement of one of the respective first drive disc 70a and second drive disc 70b and the driven disc 72, thereby incrementally changing the torque transmission ratio.

Referring to FIG. 5, the toroidal continuously variable transmission 32b of the present invention further includes a first transfer gear 88, a first intermediate shaft 90, a clutch assembly 92, a second transfer gear 94, a third transfer gear 96, a second intermediate shaft 98, a fourth transfer gear 100, and a front differential 102.

The driven disc 72 functions as the transmission output. The driven disc 72 is operatively connected to the first transfer gear 88. The first transfer gear 88 is configured to receive torque from the driven disc 72 and further configured to transmit torque to the first intermediate shaft 90.

The toroidal continuously variable transmission 32b further includes a clutch assembly 92 contained within a clutch housing 93. The clutch assembly 92 includes a forward disconnect clutch 35 operatively connected to the clutch housing 93, a hollow shaft 95 disposed about the first intermediate shaft 90, and a planetary gear set 101.

The forward clutch 35 acts as a disconnect clutch, which selectively couples and decouples the continuously variable transmission 32b and the first set of drive wheels 12. When applied, the forward disconnect clutch 35 couples the clutch housing 93 and the hollow shaft 95, allowing the clutch housing 93, forward disconnect clutch 35, and the hollow shaft 95 to rotate in unison with the first intermediate shaft 90. The hollow shaft 95 and the clutch housing 93 are further operatively connected to the planetary gear set 101 and configured to transfer torque thereto, when the forward clutch 35 is applied.

When the forward disconnect clutch 35 is applied, the clutch assembly 92 transmits the output rotation from the first intermediate shaft 90 to the planetary gear set 101. When the forward disconnect clutch 35 is disengaged, the clutch assembly 92 does not transmit the output rotation from the first intermediate shaft 90 to the planetary gear set 101. This disengagement of the continuously variable transmission 32b from the first set of drive wheels 12 allows the continuously variable transmission 32b to operate in a low loss state when the vehicle 10 is operating in electric-only mode, powered by the rear e-axle assembly 22.

The planetary gear set 101 is configured to selectively receive torque from the first intermediate shaft 90 via the clutch assembly 92, when the forward disconnect clutch 35 is applied. The second transfer gear 94 is operatively connected to and configured to receive torque from the planetary gear set 101, when the forward disconnect clutch 35 is applied. The second transfer gear 94 may further be operatively connected to and configured to transfer torque to the third transfer gear 96. The third transfer gear 96 may be operatively connected to and configured to transfer torque to the second intermediate shaft 98. The second intermediate shaft 98 may be operatively connected to and configured to transmit torque to the fourth transfer gear 100. The fourth transfer gear 100 may be operatively connected to and configured to transmit torque to the front differential 102.

The front differential 102 is operatively connected to and may be housed within the fourth transfer gear 100. The front differential 102 is configured to receive torque from the fourth transfer gear 100 and further configured to transmit torque from the continuously variable transmission 32b to the first set of drive wheels 12, via an output device, i.e., the first axle 44.

Referring back to FIG. 1, the hybrid-electric vehicle 10 may further include a controller 150. The controller 150 may be a stand-alone unit, or be part of an electronic controller that regulates the operation of the engine 18 and the first and second electronic power components 16, 20. The controller 150 may be embodied as a server/host machine or distributed system, e.g., a digital computer or microcomputer, acting as a vehicle control module, and/or as a proportional-integral-derivative (PID) controller device having a processor, and tangible, non-transitory memory such as read-only memory (ROM) or flash memory. The controller 150 may also have random access memory (RAM), electrically erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. As envisioned herein, the controller 150 may be an electronic control unit (ECU) that is configured, i.e., programmed and equipped in hardware, to regulate and coordinate the hybrid propulsion of the vehicle 10, which includes the operation of the engine 18, the continuously variable transmission 32a, 32b and the first and second electronic power components 16, 20.

The controller 150 is configured to receive a request for the engine 18 to be started, when the vehicle 10 is being driven by the rear e-axle 22, which is powered solely via the second electronic power component 16. The controller 150 is programmed to control the application of the forward disconnect clutch 35 inside the continuously variable transmission 32a, 32b. The controller 150 is further configured to control the engine 18 to generate the desired level of transmission output torque according to the selected drive mode, i.e., electric-only operating mode, hybrid operating mode, and engine-only operating mode.

Referring to FIG. 6, a method 200 of transitioning an all-wheel drive hybrid electric vehicle between a present operating mode and a target operating mode, wherein the present operating mode is the electric-only mode and the target operating mode is the hybrid mode is also provided. Such a transition from electric-only mode, utilizing the rear e-axle 22, to all-wheel drive hybrid operating mode, wherein the vehicle receives power from both the rear e-axle assembly 22 and the internal combustion engine 18 and second electronic power component 20, may also be referred to as completing a “flying start.”

The flying start of the engine 18 is accomplished by the controller 150 that is responsible for phasing in of engine torque for driving the vehicle 10. When the vehicle 10 is driven in electric-only mode, the vehicle 10 is powered solely by the second electronic power component 16, while the engine 18 is shut-off and the continuously variable transmission 32a, 32b is placed in neutral, to operate in a low loss state in order to conserve fuel and improve the vehicle's operating efficiency. The engine 18 may be shut-off when the vehicle 10 is maintaining a steady cruising speed, which may be sustained solely by the torque output of the second electronic power component 16. Additionally, the engine 18 may be shut-off when the vehicle 10 is in a coast mode, i.e., when decelerating or the vehicle is stopped. At any time when the vehicle 10 is operating on torque supplied solely by the second electronic power component 16, the engine 18 may need to be restarted to place the vehicle 10 in hybrid mode or engine-only mode. In such situations, the engine 18 is called upon to generate an appropriate level of engine torque to result in the required amount of transmission torque, i.e., transmission torque at the transmission output 42, 72.

The flying start is accomplished by the controller 150, when the controller 150 completes the following steps, detailed in FIG. 6. At step 201, the controller 150 detects a request for a change from the present operating mode to the target operating mode.

At step 202, the controller 150 signals a desired change from the present operating mode to the target operating mode.

At step 203, the controller 150 starts the first electric power component 20 with power from the power storage device 28, allowing the first electronic power component 20 to crank the engine 18 in order to generate the desired level of transmission output torque.

At step 204, the controller 150 determines a desired engine speed and a gear ratio of the continuously variable transmission 32a, 32b to produce the desired level of transmission output torque;

At step 205, the controller 150 engages the forward disconnect clutch 35 to couple the continuously variable transmission 32a, 32b with the first set of drive wheels 12.

At step 206, the vehicle 10 is powered with torque transferred from the continuously variable transmission 32a, 32b to the first set of drive wheels 12 and torque transferred from the second electric power component 16 to a second set of drive wheels 14 in the target operating mode, i.e., the hybrid operating mode.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A hybrid-electric vehicle comprising:
a first set of drive wheels and a second set of drive wheels;
a primary power source having a rotatable output member;
a continuously variable transmission configured to transmit torque from the power source to the first set of drive wheels, wherein the continuously variable transmission includes a forward disconnect clutch configured to selectively couple and decouple the continuously variable transmission and the first set of drive wheels; and
an auxiliary power source operatively connected to the second set of drive wheels and configured to transmit torque thereto.

2. The hybrid-electric vehicle of claim 1 wherein the primary power source includes an internal combustion engine and a first electronic power component, the first electronic power component configured to crank the engine.

3. The hybrid-electric vehicle of claim 1 wherein the auxiliary power source includes a second electronic power component having a second electronic power component output.

4. The hybrid vehicle of claim 1 wherein the continuously variable transmission is a belt-type continuously variable transmission.

5. The hybrid vehicle of claim 4 wherein the continuously variable transmission includes:
a first pulley having a first pulley axle defining a first pulley diameter and rotatable about an input axis, wherein the first pulley defines an annular input groove;
a second pulley, defining an annular output groove, the second pulley having a second pulley axle defining a second pulley diameter, the second pulley axle rotatable about an output axis, wherein the second pulley is a driven pulley connected to rotate with the first pulley;
a transmission input member extending along the input axis, the transmission input member operatively connected to the rotatable output member of the primary power source and operatively connected to and configured to rotate with the first pulley axle;
a transmission output member extending along the output axis and operatively connected to and configured to rotate with the second pulley axle;
an endlessly rotatable device looped around the first pulley axle and the second pulley axle and disposed within the annular input groove and the annual output groove and operable to transmit torque from the first pulley to the second pulley, wherein the endless rotatable device is moveable radially relative to the input axis and the output axis respectively to change a torque transmission ratio between the transmission output member and the transmission input member; and
wherein the ratio of the second pulley diameter to the first pulley diameter defines the transmission torque ratio.

6. The hybrid-electric vehicle of claim 5 wherein the forward disconnect clutch is disposed on the transmission output member and configured to selectively couple and decouple the transmission output member and the first set of drive wheels.

7. The hybrid electric vehicle of claim 6 wherein the continuously variable transmission further includes:
a clutch assembly disposed within a clutch housing, the clutch assembly including:
the forward disconnect clutch configured to couple and decouple the continuously variable transmission from the first set of drive wheels;
a hollow shaft disposed about the transmission output member and configured to receive torque from the transmission output member when the forward disconnect clutch is applied; and
a planetary gear set configured to receive torque from the hollow shaft when the forward disconnect clutch is applied;
at least one transfer gear configured to receive torque from the planetary gear set; and
a front differential configured to receive torque from the at least one transfer gear and further configured to transmit torque to the first set of drive wheels.

8. The hybrid-electric vehicle of claim 1 wherein the continuously variable transmission is a toroidal continuously variable transmission.

9. The hybrid-vehicle of claim 8 wherein the toroidal continuously variable transmission includes:
a transmission input member operatively connected to and rotatable with the output member of the primary power source;
a pair of opposed drive discs including a first drive disc and a second drive disc, the pair of drive discs integrally rotatable with the transmission input member;
a driven disc disposed between the first drive disc and the second drive disc, wherein the first drive disc and the driven disc define a first cavity having a first toroidal surface; wherein the second drive disc and the driven disc define a second cavity having a second toroidal surface; and wherein the first drive disc, the second drive disc, and the driven disc are disposed along and rotatable about a common input axis; and
at least one roller mechanism disposed within each of the first cavity and the second cavity, each roller mechanism configured to transfer torque from one of the first drive disc and second drive disc to the driven disc, wherein each roller mechanism moves along one of the respective first toroidal surface and second toroidal surface to vary the ratio between the speed of the transmission input member and the driven disc.

10. The hybrid-electric vehicle of claim 9 wherein the continuously variable transmission further includes:
a first transfer gear operatively connected to the driven disc and configured to receive torque from the driven disc;
a first intermediate shaft operatively connected to the first transfer gear and configured to receive torque from the first transfer gear;
a clutch assembly disposed within a clutch housing, the clutch assembly including:
the forward disconnect clutch configured to couple and decouple the continuously variable transmission and the first set of drive wheels;
a hollow shaft disposed about the first intermediate shaft and configured to receive torque from the first intermediate shaft when the forward disconnect clutch is applied; and
a planetary gear set configured to receive torque from the hollow shaft when the forward disconnect clutch is applied.

11. The hybrid-electric vehicle of claim 10 wherein the continuously variable transmission further includes:
a second transfer gear operatively connected to the planetary gear set and configured to receive torque from the planetary gear set;
a third transfer gear operatively connected to the second transfer gear and configured to receive torque from the second transfer gear;
a second intermediate shaft operatively connected to the third transfer gear and configured to receive torque from the third transfer gear;
a fourth transfer gear operatively connected to the second intermediate shaft and configured to receive torque therefrom; and
a front differential housed within the fourth transfer gear and configured to receive torque therefrom, the front differential further configured to transmit torque from the second intermediate shaft to the first set of drive wheels.

12. The hybrid-electric vehicle of claim 9 wherein each of the respective roller mechanisms apply a lateral force to one of the respective first drive disc and second drive disc and the driven disc to define a transmission torque ratio between the transmission input member and the driven disc.

13. The hybrid-electric vehicle of claim 3 wherein the vehicle further includes a rear differential operatively connected to the second electric power component output, the rear differential configured to transmit torque from the second electric power component output to the second set of drive wheels.

14. The hybrid-electric vehicle of claim 3 wherein the vehicle has an electric-only operating mode and a hybrid operating mode, such that second electric power component propels the vehicle, via the second set of drive wheels, with power generated solely by the second electric power component in the electric-only operating mode.

15. The hybrid-electric vehicle of claim 14 wherein the transmission disconnect clutch is disengaged, when the vehicle is operated in the electric-only operating mode, such that the continuously variable transmission is decoupled from the first set of drive wheels allowing the continuously variable transmission to operate in a low loss state.

16. The hybrid-electric vehicle of claim 2 wherein the first electric power component is a first motor-generator unit.

17. The hybrid-electric vehicle of claim 3 wherein the second electric power component is on of an electric motor and a second motor-generator unit.

18. The hybrid vehicle of claim 14 further including a controller configured to initiate a transition from the electric-only operating mode to the hybrid operating mode.

19. The hybrid vehicle of claim 18 wherein the controller is further configured to:
detect a request for a change from the electric-only operating mode to the hybrid operating mode;
signal a desired change from the electric-only operating mode to the hybrid operating mode;
start the first electric power component to crank the engine;
determine a desired engine speed and desired engine torque to produce the desired transmission torque;
engage the forward disconnect clutch to couple the continuously variable transmission with the first set of drive wheels; and
powering the vehicle with torque transferred from the continuously variable transmission to the first set of drive wheels and torque transferred from the second electric power component to the second set of drive wheels in the hybrid operating mode.

20. A method of transitioning an all-wheel drive hybrid-electric vehicle between a present operating mode and a target operating mode comprising:
detecting, via a controller, a request for a change from the present operating mode to the target operating mode, wherein the present operating mode is an electric-only operating mode and the target operating mode is a hybrid operating mode;
signaling, via the controller, a desired change from the present operating mode to the target operating mode;
starting a first electric power component to crank an engine of the vehicle;
determining, via the controller, a desired engine speed and a desired engine torque to generate the desired level of transmission output torque;
engaging a forward disconnect clutch to selectively couple a continuously variable transmission with a first set of drive wheels, such that the torque from the continuously variable transmission is transferred to the first set of drive wheels; and
powering the vehicle with torque transferred from the continuously variable transmission to a first set of drive wheels and torque transferred from a first electric power component to a second set of drive wheels in the target operating mode.
